(19) United States
(12) Patent Application Publication
(10) Pub. No.: US 2022/0269704 A1
(43) Pub. Date: Aug. 25, 2022

(54) IRRELEVANCY FILTERING

(71) Applicant: Black Swan Data Ltd., London (GB)

(72) Inventor: Richárd József Farkas, Szeged (HU)

(21) Appl. No.: 17/604,741

(22) PCT Filed: Apr. 16, 2020
(86) PCT No.: PCT/GB2020/050960

§ 371 Date: Oct. 18, 2021

(30) Foreign Application Priority Data
Apr. 18, 2019 (GB) 1905548.2

(51) Int. Cl. G06F 16/335; G06F 16/33; G06F 16/35; G06F 16/36

(52) U.S. Cl. CPC G06F 16/335; G06F 16/3344; G06F 16/35; G06F 16/36

(57) ABSTRACT

The present invention relates to filtering textual data based on topic relevancy. More particularly, the present invention relates to generating training data to train a computer model to substantially filter out irrelevant data from a collection of data that may include both irrelevant and relevant data. Aspects and/or embodiments seek to provide a method for filtering data when generating datasets of short-form data for topics of interest. Aspects and/or embodiments also seek to provide a training dataset that can be used to train a computer model to perform relevancy/irrelevancy filtering of short-form data using relevant and irrelevant extracts from long-form data.

### FIELD

The present disclosure relates to filtering textual data based on topic relevancy. More particularly, the present disclosure relates to generating training data to train a computer model to substantially filter out irrelevant data from a collection of data that may include both irrelevant and relevant data.

### BACKGROUND

Text documents published online through such channels as social media, news, blogs, forums, and reviews are a potentially valuable set of data that can be used for understanding themes or topics that are of interest to individuals and social circles, as well as related opinions about those themes or topics. Other than detecting the themes and topics themselves, there are various applications which require the quantification of the size or frequency of a theme, for example the volume of conversation relating to a theme in a dataset. For example, in trend detection, an important building block for models includes a count of posts or post frequency for a particular theme or topic within a timeframe.

One of the most important technical challenges in trend detection is understanding context at scale. Humans can innately understand the context in which a word or set of words is used but are unable to read and process the scale of documents that are published online. A solution is needed to help accurately determine context at scale. There are three main types of context that need to be determined, for each queried keyword or topic. The first type of context is disambiguation. Human language is messy, and the same word with the same spelling is often used with different meaning depending on the context. For example, the word ‘Turkey’ could refer to the country, to the food, or to the phrase ‘going cold turkey’. Similarly, Apple could refer to the fruit or to the company. It is important when assigning a document to a trend, that we understand which meaning of the word is intended. The second type of context needed is to understand the overall category in which the keyword or topic is being discussed. For example, vitamin cream and vitamin supplements—both use the same meaning of the word vitamin, but for trend tracking is important to understand if the document is referring to the skincare product (vitamin cream) or the product for human consumption (vitamin supplements). Finally, the third type of context is for intended usage within a desired category. For example, the word espresso can be meant as a drink on its own, or as an ingredient in a cocktail. Understanding the context in which the word is used helps to determine what type of trend is being discussed.

Current techniques for analysing the data available via sources like social media typically focus on “well-defined” topics, for example “food & drink”. These techniques define a set of query words and retrieve a dataset for each set of query words. This dataset then forms the basis for deeper analysis such as topic modelling and quantification of themes within that dataset. These current techniques, however, face the three context challenges described above as the precision of the query, and accuracy of categorisation, are low or sub-optimal due to ambiguous query words used in the process. This use of ambiguous query words generates a dataset that typically contains a significant proportion of content or documents which do not belong to the topic category in question. For example, the word “chips” has at least three different meanings which may only be evident through context or semantic analysis. For example, “crisps”, “poker chips”, and “computer chips”—but in this example, only the first belongs to the “food & drink” topic category that is of interest.

An additional challenge is that current techniques for understanding topics rely heavily on topic modelling approaches—however those topic modelling approaches are designed for longer documents and struggle to perform on documents of the size that are normally produced on social media platforms. Given the volume of “short-form” content on social media platforms and other online websites, most short-form content is deemed not to be relevant for accurate topic modelling and this assumption typically creates inaccurate prediction trends for topics, as the “short form” content is not taken into account. Current techniques take this approach because they face the difficulty of filtering out irrelevant short-form content as well as noise created in the ecosystem by automated bots and spam.

Currently, is it difficult for these known techniques to understand conversations in context. For example, when referring to “coffee”, the deemed relevant data could include conversations or data relating to “coffee tables”, which introduces completely irrelevant data into the dataset for the given query. In another example, when considering the drink “lemonade”, the data acquired by current methods may include a particularly famous pop song having that name.

Therefore, when considering typically millions of documents at a time when dealing with these types of dataset, it is difficult to filter which pieces of content are relevant to a particular topic, and which are not relevant. The human language is complex, and at times ambiguous, thus creating a difficult task for filtering methods and systems to generate a relevant dataset for analysis.

### SUMMARY OF INVENTION

Aspects and/or embodiments seek to provide a method for filtering data when generating datasets including short-form data for topics of interest. Aspects and/or embodiments also seek to provide a training dataset that can be used to train a computer model to perform relevancy/irrelevancy filtering using short-form data using relevant and irrelevant extracts from long-form data.

According to a first aspect, there is provided a method of filtering data based on relevancy to a topic, the method comprising: receiving an input dataset, wherein the input dataset comprises a second type of data; determining one or more relevancy scores of the input dataset using a learned algorithm; wherein the learned algorithm is trained using a second dataset; wherein the second dataset comprises extracts comprising one of a plurality of taxonomy keywords from a first type of data; wherein the first type of data has a relevancy score within a predetermined threshold; wherein the relevancy score for each of the first type of data is based on a comparison between each of the first type of data and a seed list; wherein the seed list comprises at least one relevant term to the topic; wherein a reference database comprises the first dataset, the first set dataset comprising a plurality of the first type of data, the topic comprising a plurality of taxonomy keywords; and filtering the input dataset based on the one or more relevancy scores of the input dataset.

According to a further aspect, there is provided a method of filtering data based on relevancy to a topic, the method comprising: receiving an input dataset, wherein the input dataset comprises a second type of data; determining one or more relevancy scores of the input dataset using a learned algorithm wherein the learned algorithm is trained using a second dataset, and wherein the second dataset comprises a second type of data generated from a first dataset, and wherein the first dataset comprises a first type of data; wherein generating the second dataset from the first dataset comprises determining a relevancy score of the first dataset to the topic and extracting data from the first dataset with a relevancy score above a predetermined threshold; and filtering the input dataset based on the determined one or more relevancy scores of the input dataset.

According to a second aspect there is provided a method of determining relevancy to a topic (of data and/or a(n input) dataset), the method comprising: receiving an/the input dataset, wherein the input dataset comprises a second type of data; determining one or more relevancy scores of the input dataset using a learned algorithm; wherein the learned algorithm is trained using a second dataset; wherein the second dataset comprises extracts comprising one of a plurality of taxonomy keywords from a first type of data; wherein the first type of data has a relevancy score within a predetermined threshold; wherein the relevancy score for each of the first type of data is based on a comparison between each of the first type of data and a seed list; wherein the seed list comprises at least one relevant term to the topic; wherein a reference database comprises the first dataset, the first set dataset comprising a plurality of the first type of data, the topic comprising a plurality of taxonomy keywords; and outputting the one or more relevancy scores.

According to a further aspect there is provided a method of determining relevancy to a topic (of data and/or a(n input) dataset), the method comprising: receiving an input dataset, wherein the input dataset comprises a second type of data; determining one or more relevancy scores of the input dataset using a learned algorithm wherein the learned algorithm is trained using a second dataset, and wherein the second dataset comprises a second type of data generated from a first dataset, and wherein the first dataset comprises a first type of data; wherein generating the second dataset from the first dataset comprises determining a relevancy score of the first dataset to the topic and extracting data from the first dataset with a relevancy score above a predetermined threshold; and outputting the determined one or more relevancy scores.

According to a third aspect, there is provided a method for filtering data based on relevancy to a topic, the method comprising: receiving a reference database for at least one topic, the reference database comprising a first dataset, the first dataset comprising a plurality of a first type of data, the topic comprising a plurality of taxonomy keywords; receiving at least one seed list, wherein the seed list comprises at least one relevant term to the topic; determining a relevancy score for each of the first type of data is based on a comparison between the each of the first type of data and the seed list; and generating a second dataset comprising extracts comprising one of the plurality of taxonomy keywords from each of the first type of data wherein, the first type of data has a relevancy score within a predetermined threshold. Optionally, the relevancy score can be output. Optionally, the relevancy score is used to filter any or any combination of the first dataset, the second dataset, or another dataset. Optionally, the relevancy score is used to filter data. Optionally filtering is performed using a predetermined threshold of relevancy score.

Optionally, the first dataset further comprises a second type of data. Optionally, the first type of data comprises long-form data and/or the second type of data comprises short-form data.

Filtering data in a second dataset (e.g. short-form data) to identify relevant or irrelevant data for a particular topic of interest using a dataset generated from extracts from relevant and/or irrelevant data in a first dataset (e.g. long-form content) can enable a determination of relevancy to a particular topic of interest in datasets that would otherwise too difficult to filter.

The reference database can include a query list or taxonomy of keywords that are known to be associated to a particular topic and can also include long-form data (first type of data/first dataset) and/or short-form data (second type of data/second dataset). In comparison to short-form data, the use of long-form data in the first dataset can enable the overall context of the conversation, blog post, article or journal to be properly determined for a, or a number of, topics. When filtering for a specific topic, a seed list comprising a list of terms or keywords identified to include the highest likelihood of relevancy to the specific topic can be leveraged against the first dataset to ascertain a relevancy score for each document within the first dataset. Extracts deemed highly reliable/relevant from the first dataset that represent the relevancy to the topic can then be used to create a second dataset which can be used as training data for computer-based models.

Two general forms of content data used in embodiments include long-form data/content and short-form data/content. As an example, long-form content can describe conversations from message boards like Reddit®, news articles, blog posts, product reviews, news articles, etc., which provide a wealth of information when scanned and searched for topics. However, short-form content typically ranges from 1 to 280 characters and are often part of conversations or posts arising from social media platforms such as Twitter®, VK® (in Russia) and Weibo® (in China). Too often, and as mentioned above, it is difficult to ascertain topic relevancy looking at short-form data alone. Therefore, instead long-form content can be used for the creation of training dataset for use with short form data.

Optionally, the step of determining a relevancy score further comprises determining a computational representation for the first dataset. Optionally, the step of determining a relevancy score is performed using topic modelling. Optionally, topic modelling comprises a Latent Dirichlet Allocation model, Explicit Semantic Analysis, Latent Semantic Indexing, and/or Neural Topic Modelling.

Topic modelling for short content, such as a tweet for example, can typically not give enough context for detecting the topic or even sub-topics embedded within the content. Topic modelling, on the other hand, can usually achieve good results on datasets consisting of long-form contents like blogs, product reviews, and news articles. Thus, through the use of topic modelling, example embodiments can enable an unsupervised solution for irrelevancy filtering on short-form content which leverages standard topic models calculated on long-form social media sources.

Latent Dirichlet Allocation (LDA), a statistical model for discovering the abstract topics that occur in a collection of documents, is one of many possible approaches that can be used for the topic modelling according to at least some embodiments. LDA is a generative statistical model that can allow sets of observations to be explained by unobserved groups that explain why some parts of the data are similar. Also, training an LDA model can assist in generating useful topic distributions.

Given the volume of short-form content on social media platforms and other online websites, most short-form content is typically deemed not to be relevant for accurate topic modelling and thus, as mentioned above, is discarded from being analysed so can create inaccurate prediction trends for topics. Current techniques face difficulty in filtering out irrelevant short-form documents as well as noise created in the ecosystem by automated bots and spam.

Optionally, a first topic distribution is determined for the first type of data; and a second topic distribution is determined for the seed list. Optionally, the step of determining a relevancy score comprises a comparison between the first topic distribution and the second topic distribution. Optionally, the comparison between the first topic distribution and the second topic distribution comprises a cosine similarity.

Topic distributions can be formulated for long-form content and keywords, where the keywords may be those embedded within a seed list or within broad taxonomies which are input as part of a reference database. In order to determine a relevancy score for a first dataset, the topic distributions of a content and the topic distributions for the seed list, often presented as computational representations, can be compared quantitatively using a cosine similarity algorithm. Cosine similarity scoring can be favourable in determining similarities of large datasets which are vectorised.

Optionally, the predetermined threshold comprises an upper percentile of the relevancy scores for each of the first type of data and/or a lower percentile of the relevancy scores for each of the first type of data. Optionally, the upper percentile is indicative of relevant data and the lower percentile is indicative of irrelevant data. Optionally, the upper percentile is 90 percent and the lower percentile is 10 percent. Optionally, the predetermined threshold is a user configurable variable.

Based on these relevancy scores determined for each document of the first dataset, the upper percentile and lower percentile documents can be selected and short text extracts of each mention of the queried words can then be extracted for all keywords in a taxonomy for that topic. These extracts can be +/−5 token windows or can be to generated short-form content usually seen in the form of a tweet. This step can generate a training dataset of short textual contexts of query keywords or terms which can act as a simulation of short-form content that is labelled to be either relevant or irrelevant for topics.

Optionally, the method further comprises performing heuristic techniques on the second dataset to filter and balance the second dataset.

These unsupervised machine learning techniques can enable the automatic generation of the training dataset.

Optionally, the seed list comprises terms that define the intent for relevancy. Optionally, the seed list comprises an automatically generated list of terms based on the plurality of taxonomy keywords. Optionally, the seed list is a user defined input.

In doing so, the task of ascertaining a relevancy score can be weighted based on the keywords or terms provided in the seed list, since it is the topic distribution of the seed list that is compared to the topic distribution of the first dataset. The seed can be manually inputted by a user or a sample seed list can be provided for a user which can then be further refined and amended.

For topics, there can be associated taxonomies which are very broad. Taxonomy keywords can be provided alongside the input dataset while the seed list can substantially define the user's intent for topic relevancy. Certainly, the labelling of taxonomy keywords to topics is typically not perfect which can lead to irrelevant documents being captured in the dataset but still, in rare scenarios, falling into the top percentile of relevancy scores (suggesting high relevancy). Further, sometimes an identified relevant document can contain potentially irrelevant content within the document as well as relevant content. However, errors in the training data can be mitigated by quantity of content, datasets, and user inputs. The approach can be unsupervised and can be carried out automatically for various topic-based keyword datasets.

Optionally, the extracts of the second dataset share the relevancy score of its corresponding first type of data. Optionally, the second dataset is a training dataset. In this way, the extracts form a short-form representation of its corresponding long-form counterpart.

Due to this relationship, the generated short-form extracts can also be given the same relevancy score as the long-form content it originated from.

Optionally, the data comprises social-media based textual data.

There is a need for filtering methods/systems which can be used for all or selected social media platforms. Current techniques do not provide deep analysis of social media data and can result in inaccurate in filtering of irrelevant data.

According to a fourth aspect, there is provided a method for training a computer based model, wherein the computer based model is suitable for filtering data based on relevancy to a topic, the method comprising: receiving a dataset comprising extracts comprising one of a plurality of taxonomy keywords from each of a first type of data wherein the first type of data has a relevancy score within a predetermined threshold; wherein the relevancy score for each of the first type of data is based on a comparison between the each of the first type of data and a seed list; wherein the seed list comprises at least one plurality of relevant terms to the topic; and wherein the topic comprises a plurality of taxonomy keywords.

Optionally, the computer-based model comprises any of: a regression model, a learning-to-rank model, logistic regression classifier, and/or a linear classifier.

Obtaining short text extracts that are categorised or labelled as either substantially relevant or substantially irrelevant, as a training dataset, can be useful for training a regressor or classifier. By training a regressor or classifier using these highly relevant and highly irrelevant topics that are created based on the first type of data (long-form data), the regressor or classifier can better determine a more accurate output relevancy score for short-form content.

Machine learning models/classifiers are an approach operable to provide an output based on these one or models having been trained using example data and outputs (for example a probabilistic classifier or a logistic regression classifier). Therefore, machine learning models/classifiers can provide a useful tool to more efficiently analyse data and produce one or more classifications regarding the input data based on real-time or previously analysed data.

According to a fifth aspect, there is provided a method of classifying data, using a computer-based model trained using the method above, for filtering data based on relevancy to a topic, the method comprising: receiving a second type of data as an input for the computer-based model; and determining whether the second type of data is relevant to the topic, optionally, the method further comprises an output relevancy score for the second type of data, the output relevancy score indicating whether the second type of data is relevant to the topic.

According to a further aspect, there is provided a system comprising a computer operable to perform any method above.

According to a further aspect, there is provided a computer program comprising instructions which, when the program is executed by a computer, cause the computer to carry out the steps of any method above.

### BRIEF DESCRIPTION OF DRAWINGS

Embodiments will now be described, by way of example only and with reference to the accompanying drawings having like-reference numerals, in which:

FIG. 1 shows an overview of the training process for a filtering system; and

FIG. 2 shows an example graphical representation of an example two-stage approach provided for filtering data based on topic relevancy according to an embodiment.

### SPECIFIC DESCRIPTION

Embodiments seek to provide a method for filtering data based on relevancy to a topic to substantially filter out irrelevant content. This filtering can then be implemented in applications such as determining accurate topic-based trend analysis.

The large amount of social media content such as posts or conversations from around the world can in theory be used to predict or analyse trends for a variety of reasons. In general, online text data falls into two general categories. The first category is “long-form” data and the second category is “short-form” data. In the following embodiments, “long-form” content and “short-form” content each represent a first type of data and a second type of data respectively.

As a general example, long-form content such as, for example, conversations from message boards like Reddit®, blog posts, product reviews, and news articles can be scanned and searched for content relating to for example products, ingredients, and benefits. In contrast, short-form content generally ranges from anywhere between 1 to 140 or 140 to 280 characters, such as posts on social media platforms such as Twitter®, VK® (in Russia) and Weibo® (in China), and can be harder to assess because such posts might be a part of a large conversation that is relevant but the individual posts may not appear relevant, for example.

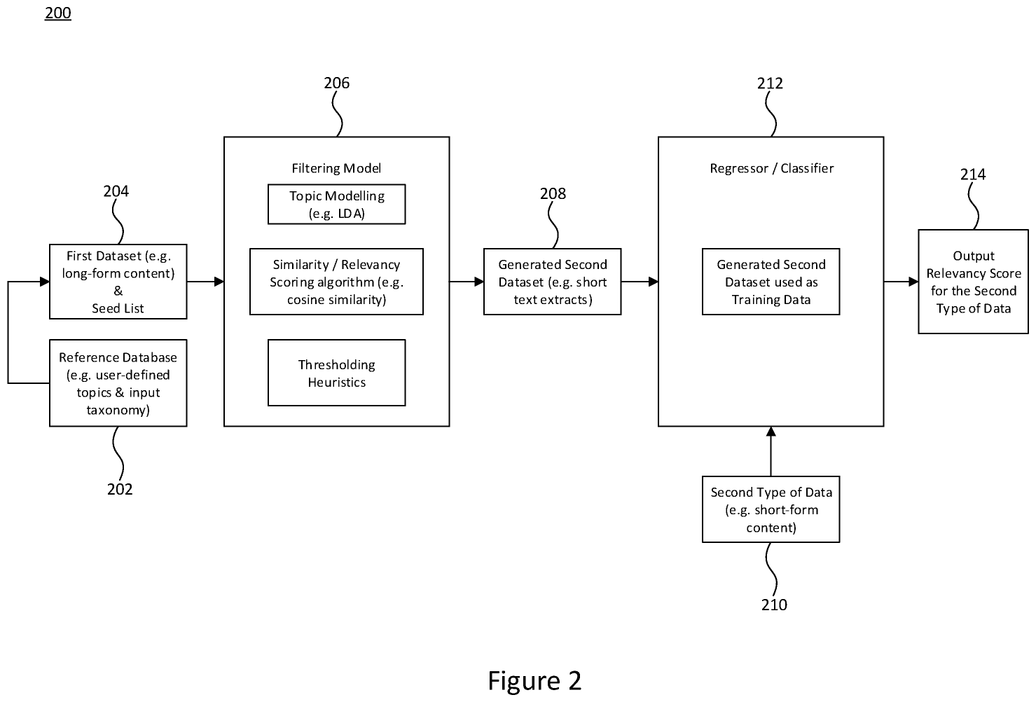

According to a first embodiment, a method of training a topic model 200 will be described herein with reference to FIG. 2. This method 200 makes use of a first dataset 204 which includes long-form content, and relevancy scores determined by a filtering model 206 for each of the data based on a topic category. The first dataset 204 is used to generate a second dataset 208 which is then used as a training dataset. Optionally, the first dataset 204 may be made up of both long-form data and short-form data.

The training dataset 208 can be used by computer models 212 to determine the relevancy score 214 of short-form data 210 input into the models 212.

In at least some embodiments, the task of filtering out irrelevant short-form content is addressed. The task of irrelevancy filtering is to automatically detect documents within a dataset which are irrelevant for a given topic category, and likewise for relevancy filtering the task is to automatically detect documents within a dataset which are relevant for a given topic category.

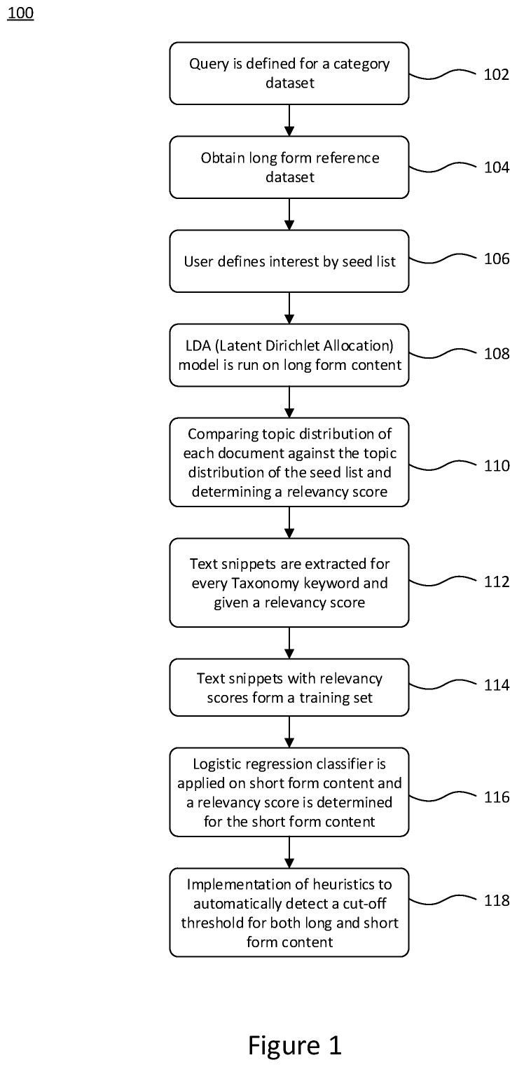

Referring now to FIG. 1, as an example, users may define a topic or category by using query words representing the topic or category they are interested in as an input to the method 102. This set of words 102 may comprise an initial query list that dictates the topic to be introduced. The first dataset can be obtained in any similar way. Such input represents a reference database 202 or the creation thereof, as shown in FIG. 2, on which the filtering process can query all content of interest.

In some embodiments, it is assumed that the dataset 202 is already spam filtered and the main contribution of the irrelevancy filtering system 212 is to reduce the noise introduced by the ambiguity of query words.

In some embodiments, irrelevancy filtering is regarded as a special case of topic modelling. In embodiments it is assumed that the major portion of the dataset belongs to the topic of interest, perhaps consisting of several sub-topics, and the task is then to identify content which does not belong to the topic of interest. Although topics play an important role in irrelevancy filtering, a goal for some embodiments is to train a filtering system that determines whether each piece of content is relevant or irrelevant for a given topic, preferably based on semantics.

Topic modelling based on short-form content, such as a tweet for example, typically does not give enough context for detecting the topic or sub-topics embedded within the content. Current methods usually rely on a single source, usually a dataset acquired from Twitter, which does not provide accurate results. On the other hand, topic modelling usually achieves good results when the initial dataset comprises long-form content like blogs, product reviews, and news articles. Thus, example embodiments provide an unsupervised solution for irrelevancy filtering on short-form content which leverages relevant data from long-form sources, instead of a direct short-form topic modelling approach.

In embodiments, as exemplified above, a user may start by defining query words 102 that are relevant to a category, such as “Coffee”, to amalgamate a reference database 104. This then forms the basis of a query that pulls long-form and short-form content into the system 104, and creates an initial corpus for generating a training dataset 208 for a computer model, such as a regressor or classifier 212. In some embodiments, the creation of the reference database 202 can also be assisted by automated suggestions which may be shown to the user via a user interface.

Filtering systems according to aspects/embodiments described herein can be applied to any online or social media dataset and thus, in some embodiments, the training dataset creation and irrelevancy/relevancy filtering stages may be considered as two separate processes.

In example embodiments, a two-stage approach is described for irrelevancy filtering on short-form content 210. In the first stage, topic modelling is performed by a filtering model 206 specifically on a long-form content dataset 104 to create a training dataset 208. This stage 206 includes calculating a similarity score, otherwise described as a relevancy score, between long-form content and user-input reference terms or the “seed list” 106. The second stage comprises using the training dataset 208 to train a computer model 212 and then filter short-form content 210 using a determined output relevancy score 214; the content or groups of content having high similarity or relevancy scores 214 are regarded as ‘topic-relevant’ while the content or groups of content having low scores are regarded to be ‘topic-irrelevant’.

The user can manually, or through a semi-automated process, define the seed list 106. The seed list 106 can be created by the user to define the topic in particular interest. For example, if the initial corpus relates to energy drink consumption, the user might be interested in trendy ingredients in energy drinks, or the occasions at which people consume energy drinks, etc. Thus, the seed list 106 enables a user to further filter an initial dataset 104 for relevant or irrelevant content. In some cases, the seed list can be defined as a list of 10 to 15 most relevant terms in a topic 106, as shown in FIG. 1. The seed list 106 can be a user defined list of words that are of interest which are expected to be highly relevant/irrelevant in relation to a topic of interest. In some embodiments, the user may input more than one seed list 106 for filtering one or more datasets.

In the described embodiment, topic modelling is performed using a Latent Dirichlet Allocation (LDA) model 108 which is run on all of the long-form documents, and the topic distribution of each document is compared 110 to the topic distribution of the seed list. This produces a relevancy score ranging from 0-1 for every long-form document. To represent each of the documents using meaningful topic distributions, the Latent Dirichlet Allocation (LDA) is a statistical model for discovering the abstract topics that occur in a collection of documents and so is one of many approaches that can be used for the topic modelling. LDA is a generative statistical model that allows sets of observations to be explained by unobserved groups that explain why some parts of the data are similar.

In embodiments where the seed list 106 is generated by the user, the seed list may be defined through a Graphical User Interface (GUI) for each filtering process. Although some embodiments do not require more than one term to be present in the seed list, as topic distribution can become more accurate with more terms, in most embodiments there will be multiple terms in the seed list.

Short form content can be particularly problematic because of mistyped/abbreviated words in order for content generating users to fit within character or word count restrictions for these types of social media platform. Using a “Group Topic Modelling” approach can enable the discovery of groups among entities and topics within the corresponding content dataset. Alternatively, other methods such as pooling-based methods create meta-documents by grouping a set of tweets together. Pooling schema including, for example, author, hashtag, or temporal pooling can enable the collection of tweets and can enable the training of a basic LDA model on such grouped content.

Although an LDA model has specifically been mentioned above for its characteristics of greater accuracy and faster speed, in other embodiments any topic model that can be machine learnt for long-form content such as Latent Semantic Analysis (LSA) or Probabilistic Latent Semantic Analysis (PLSA) can be used. In this way applying topic modelling on long-form data using LDA, or the like, considerably outperforms platform specific modelling such as LDA topic modelling on Twitter®, known as Twitter®-LDA. Twitter®-LDA employs a soft pooling on authors as the tweets of a Twitter® user are drawn from the user's topic distribution and utilises the fact that a tweet generally is about a single topic.

The seed list 106 input by the user describing their particular topic category, categories of interest is referred to as a ‘C’ in the equation below, and topic distribution is calculated based on this seed list C. The relevancy of a long-form document ‘D’ in the equation below is defined as the cosine similarity between the two topic distributions of the document θ_{D} and the terms set θ_{C}:

$$relevancy = cos ( {θ}_{C} , {θ}_{D} ) = \frac{{θ}_{C} \cdot {θ}_{D}}{‖ {θ}_{C} ‖ ‖ {θ}_{D} ‖} \qquad [ 1 ]$$

In this equation, the cosine similarity provides a relevancy score which is non-binary or a scale of 0 to 1, otherwise described as a relevancy scale, where 1 is determined as highly relevant and 0 is highly irrelevant. Based on these relevancy scores the top 10% and bottom 10% documents from the first dataset can be selected and the short text extract (+/−5 token window, i.e. the neighbouring 5 words in each direction, optionally stopping when encountering punctuation) of each mention of the queried words are then extracted for all keywords in a taxonomy for that topic 112.

This step constructs a dataset 114 consisting of short textual contexts of keywords that can act as a simulation of short-form content. In this example, every short text extract taken from the bottom 10% are labelled as irrelevant and every context extracted from the top 10% are labelled as relevant. Although the top 10% and bottom 10% has been described here, the thresholds can be adjusted (e.g. top 15% and bottom 20%) to fit the needs of the user or to provide a more accurate output relevancy score for data in the second dataset.

The second dataset, which can be described as the generated training data, can be extracted from the first dataset by snipping token windows around keywords from the topic-relevant and topic-irrelevant long-form documents. It can then be assumed that each short text extract from a particular topic-irrelevant or topic-relevant document is irrelevant or relevant. This method yields an automatically generated training dataset consisting of short textual extracts for queried terms which can act as a simulation or representation of relevant and/or irrelevant short-form content. Short-form content can consist of multiple topics which may not all be of interest, which can cause frequent errors in the system leading to misclassification and misrepresentation. By taking short text extracts from long-form documents, embodiments of the filtering method/system described can be modelled to focus on keywords in a way that mimics short form content. In this way, predictions of relevant or irrelevant mentions of keywords of interest are more likely to be filtered correctly in short form content and can help in overcoming said errors.

For topics, there may be associated taxonomies which are broad and can be used to obtain the short text extracts. Taxonomy keywords are provided alongside the input dataset while the seed list defines the user's intent for relevancy. Certainly, this labelling may not be perfect as irrelevant documents can, in rare scenarios, fall into the top 10% and a relevant document can contain potentially irrelevant contexts for a query word. However, errors in this training data can be balanced by quantity of content, datasets, and user inputs and the large volume of training data generated can overvalue any noise introduced. The alternate approach would be to manually label a training dataset, which would be very labour-intensive and therefore costly but may also yield a better-quality training dataset than an automatically generated dataset. However, using some form of automation enables generating significantly more examples than would be realistically feasible with manual labelling, and a larger dataset which may have a small percentage of error is on balance assumed to be more advantageous than a small but perfect training dataset in at least some embodiments. In addition, the approach can be unsupervised and can be carried out automatically for various or topic-based keyword datasets.

In some embodiments, following the acquisition of all keywords mentioned in short text extracts and the top and bottom percentiles, an implementation of heuristics can form training data to automatically detect a cut-off threshold for both long-form and short-form contents, as shown in step 118 of FIG. 1. As an example, it is assumed that the relevancy scores follow a gamma distribution and thus determine the ranges of the two sample scores, or the cut-off thresholds. Essentially, in order to train topic modelling using long-form content, the predicted relevancy score for the whole long-form content is used for each short text extract obtained from the document in question for training a short-form relevancy scorer.

In the second stage, as shown as 212 in FIG. 2, a computer model such as a binary classifier is trained on the automatically generated training dataset built from short text extracts. The classifier is trained to be capable of making relevant/irrelevant classification predictions on the whole target short-form content dataset. In other embodiments, it is also possible to rank short-form content based on the posterior probability of the relevant class estimated by the classifier. In the latter approach, the control may be given to the user of the system to manually set the threshold they want to filter irrelevant, or less relevant, documents.

Utilising the automatically constructed training dataset of short-form content, i.e. the short text extracts from long form content, a Logistic Regression binary classifier is trained for relevant/irrelevant content prediction, as shown as step 116 in FIG. 1. Although other classifiers, as shown as in 212 in FIG. 2, may be implemented for training, such as direct regression models, Logistic Regression is used in this example embodiment as it typically performs well on textual classification tasks and the Bayesian approach provides a good estimation on posterior probability of classes. This can provide a control for the user to set up as a filtering threshold. The trained classifier is used to output a final output relevancy score for the short-form content, as shown as 214 in FIG. 2.

The frequency of the keywords in the automatically generated training dataset typically follows a power distribution. To avoid the over-representation of frequent keywords in the classifier, embodiments may randomly sample the most frequent keywords from the automatically generated training dataset. Also, because there are typically more keyword mentions in the top ranked documents then there are in the bottom ranked content, in some embodiments sampling per-class biases can be implemented to maintain substantial accuracy in classification. This can make the training dataset's label distribution of topic categories more uniform.

In further embodiments, the following features for a classifier can be used to describe the short-form contexts:
Bag-of-words representation of the contexts with 1-3 grams.
Word embedding representation of the context.
The keyword of the context

The bag-of-words representation model can be used in document classification. In using this model, short-form content can be represented as a “bag” or multiset of its words as a method of representation through Natural Language Processing (NLP). Other embodiments may use an N-gram model.

For many examples of short-form content there is typically a lack of clarity or sufficient detail to enable the performance of a substantially accurate classification. To overcome this, embodiments may implement the approach of averaging the Word2Vecs of the context, or other groups of related models, to generate word embeddings. For the utilisation of the generated word embeddings, each piece of short-form content can be represented with the mean of the word vector of their tokens, and a vector for the user can be calculated given the keyword list. This approach is capable of capturing multiple different degrees of similarity between words and semantic and syntactic patterns can be reproduced using vector arithmetic. As an example, a model such as the Google® Word2Vec Model may be pre-trained. As another example, word embeddings may be trained on the long-form category dataset to obtain a category-specific word embedding. This may be implemented using Facebook's® FastText model.

Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets.

For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information.

When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples).

Machine learning may be performed through the use of one or more of: parametric and non-parametric Bayesian approaches; linear models; a non-linear hierarchical algorithm; neural network; convolutional neural network; or a recurrent neural network.

Any system feature described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

What is claimed is:

1. A computer-implemented method comprising:
receiving an input dataset, wherein the input dataset comprises one or more short-form data;
labelling the input dataset using a trained computer model, wherein labelling the input dataset comprises applying one or more labels based on a predetermined threshold for a topic to the input dataset by the trained computer model; and
outputting a labelled dataset;
wherein the trained computer model is trained using a second dataset, and wherein the second dataset comprises short-form data generated from a first dataset, and wherein the first dataset comprises one or more long-form data; and
wherein generating the second dataset from the first dataset comprises:
using topic modelling to determine a similarity score for each of the long-form data of the first dataset based on a comparison between each of the long-form data and the topic; and
extracting data from the first dataset with a similarity score above a predetermined threshold.

2. (canceled)

3. (canceled)

4. (canceled)

5. (canceled)

6. (canceled)

7. The method of claim 1 wherein the step of determining a similarity score further comprises determining a computational representation for the first dataset.

8. The method of claim 1 wherein topic modelling comprises any of: a Latent Dirichlet Allocation model; Explicit Semantic Analysis; Latent Semantic Indexing; and/or Neural Topic Modelling.

9. The method of claim 1 wherein:
a first topic distribution is determined for the first type of data; and
a second topic distribution is determined for the seed list.

10. The method of claim 9 wherein the step of determining a similarity score comprises a comparison between the first topic distribution and the second topic distribution.

11. The method of claim 10 wherein the comparison between the first topic distribution and the second topic distribution comprises a cosine similarity.

12. The method of claim 1 wherein the predetermined threshold comprises:
an upper percentile of the similarity scores for each of the long-form data; and/or
a lower percentile of the similarity scores for each of the long-form data.

13. The method of claim 12 wherein the upper percentile is indicative of relevant data and the lower percentile is indicative of irrelevant data.

14. The method of claim 13 wherein the upper percentile is 90 percent and the lower percentile is 10 percent.

15. The method of claim 1 wherein the predetermined threshold is a user configurable variable.

16. The method of claim 1 wherein the seed list comprises terms that define the intent for labelling the input dataset.

17. The method of claim 1 further comprising a seed list, wherein the seed list comprises an automatically generated list of terms based on the plurality of taxonomy keywords, optionally the seed list is automatically suggested.

18. The method of claim 17 wherein the seed list is a user defined input.

19. (canceled)

20. The method of claim 1 wherein the method further comprises performing heuristic techniques on the second dataset to filter and balance the second dataset.

21. The method of claim 1 wherein the second dataset is a training dataset.

22. The method of claim 1 wherein the datasets comprises social-media based textual data.

23. A method for training a computer based model, the method comprising:
receiving a dataset comprising extracts comprising one of a plurality of taxonomy keywords from one or more long-form data wherein the long-form data has a similarity score within a predetermined threshold;
wherein the similarity score for each of the long-form data is based on a comparison between the each of the long-form data and a seed list using topic modelling;
wherein the seed list comprises at least one plurality of relevant terms to the topic; and
wherein the topic comprises a plurality of taxonomy keywords.

24. The method of claim 23 wherein the computer-based model comprises any of: a learning-to-rank model; logistic regression classifier;
and/or a linear classifier.

25. (canceled)

26. (canceled)

27. (canceled)

28. A method for training a computer model, the method comprising:
receiving a reference database for at least one topic, the reference database comprising a first dataset, the first dataset comprising a plurality of long-form data, the topic comprising a plurality of taxonomy keywords;
receiving at least one seed list, wherein the seed list comprises at least one relevant term to the topic;
determining a similarity score for each of the long-form data based on a comparison between the each of the long-form data and the seed list using topic modelling; and
generating a second dataset comprising extracts comprising one of the plurality of taxonomy keywords from each of the long-form data wherein, the each of the long-form data has a similarity score within a predetermined threshold.
